(19) United States
(12) Patent Application Publication
(10) Pub. No.: US 2023/0102529 A1
(43) Pub. Date: Mar. 30, 2023

(54) ROUTE INFORMATION MANAGEMENT APPARATUS, ROUTE INFORMATION MANAGEMENT METHOD AND PROGRAM

(71) Applicant: Nippon Telegraph and Telephone Corporation, Tokyo (JP)

(72) Inventors: Yukihiro TOGARI, Musashino-shi, Tokyo (JP); Shingo OKADA, Musashino-shi, Tokyo (JP); Hisashi KOJIMA, Musashino-shi, Tokyo (JP); Saburo SETO, Musashino-shi, Tokyo (JP)

(21) Appl. No.: 17/801,986

(22) PCT Filed: Feb. 25, 2020
(86) PCT No.: PCT/JP2020/007462

§ 371 Date: Aug. 24, 2022

(51) Int. Cl. H04L 45/586; H04L 45/44

(52) U.S. Cl. CPC H04L 45/586; H04L 45/44

(57) ABSTRACT

A path information managing apparatus includes a storage unit configured to store, in association with a virtual IP address, a locator of each of a plurality of aggregation routers and a locator of each of a plurality of virtual accommodation routers that are accommodated in each aggregation router and accommodate cluster, an acquisition unit configured to acquire the locator of the aggregation router associated with the virtual IP address and the locator of each virtual accommodation router, in response to an inquiry for a virtual IP address to a destination of a packet, the inquiry being transmitted from an accommodation router that receives the packet from a terminal, and a transmission unit configured to transmit, to the accommodation router, the acquired locator of the aggregation router, the acquired locator of each virtual accommodation router, and a weight of each virtual accommodation router, or the locator of any virtual accommodation router.

### TECHNICAL FIELD

The present invention relates to a path information managing apparatus, a path information managing method, and a program.

### BACKGROUND ART

As a technique in the related art, there has been proposed an architecture that realizes End-to-End communication even in a multi-carrier/multi-access environment by linking an endpoint identifier (EID) of a terminal/application and a locator (RLOC (Routing Locator)) of a provider edge router (PE) that accommodates EIDs and managing the linking (NPL 1). The “End-to-End communication” means resolving the RLOC of virtual customer premises equipment (vCPE) of a communication destination and performing communication on an overlay network in which the RLOC is specified.

### CITATION LIST

### Non Patent Literature

NPL 1: RFC6830 The Locator/ID Separation Protocol (LISP)
NPL 2: IETF Anycast Segments in MPLS based Segment Routing
NPL 3: CNCF, Intro+Deep dive SIG Multi-Cluster
NPL 4: IETF Segment Routing Policy Architecture

### SUMMARY OF THE INVENTION

### Technical Problem

In the above architecture, to selectively use a base (for example, data center) of the communication destination in accordance with a network (or physical) position assuming that a terminal (for example, a vehicle) moves, a mechanism is required that can perform routing by anycast using a VIP common to each cluster for an EID of the communication destination specified by the terminal.

For example, FIG. 1 illustrates a state in which a vehicle (vehicle in which a CPE is mounted) connected to a vCPE of a base A such as a data center and to be accommodated in a PE3 in a state of being accommodated in a PE1 is accommodated in a PE2 after movement. In this state, if a PE4 is closer to the PE2 than the PE3, it is desirable to be routed to the vCPE in a base B or a base C accommodated in the PE4.

In a case where a VIP is specified to the destination (EID), it is not possible to uniquely specify a path for a connection destination because there are a plurality of bases corresponding to the destination (EID) (in FIG. 1, the base A, the base B, and the base C correspond to the same EID), and the path of the connection destination cannot be uniquely specified.

The present disclosure has been made in view of the above circumferences, and an object is to make it possible to uniquely specify a path for a connection destination even in a case where a virtual IP address is specified to a destination.

### Means for Solving the Problem

Thus, in order to solve the above problems, a path information managing apparatus includes a storage unit configured to store a locator of each of a plurality of aggregation routers and a locator of each of a plurality of virtual accommodation routers that are accommodated in each of the aggregation routers and accommodate clusters, in association with a virtual IP address, an acquisition unit configured to acquire the locator of the aggregation router associated with the virtual IP address and the locator of each of the plurality of virtual accommodation routers in the storage unit in response to an inquiry for a virtual IP address designated to a destination of a packet, the inquiry being transmitted from an accommodation router that has received the packet from a terminal, and a transmission unit configured to transmit, to the accommodation router, the acquired locator of the aggregation router, the acquired locator of each of the plurality of virtual accommodation routers, a weight of each of the plurality of virtual accommodation routers, or the locator of any one of the plurality of virtual accommodation routers.

### Effects of the Invention

A path for a connection destination can be uniquely specified even in a case where a virtual IP address is specified to a destination.

### BRIEF DESCRIPTION OF DRAWINGS

FIG. 1 is a diagram for describing a problem in the related art.

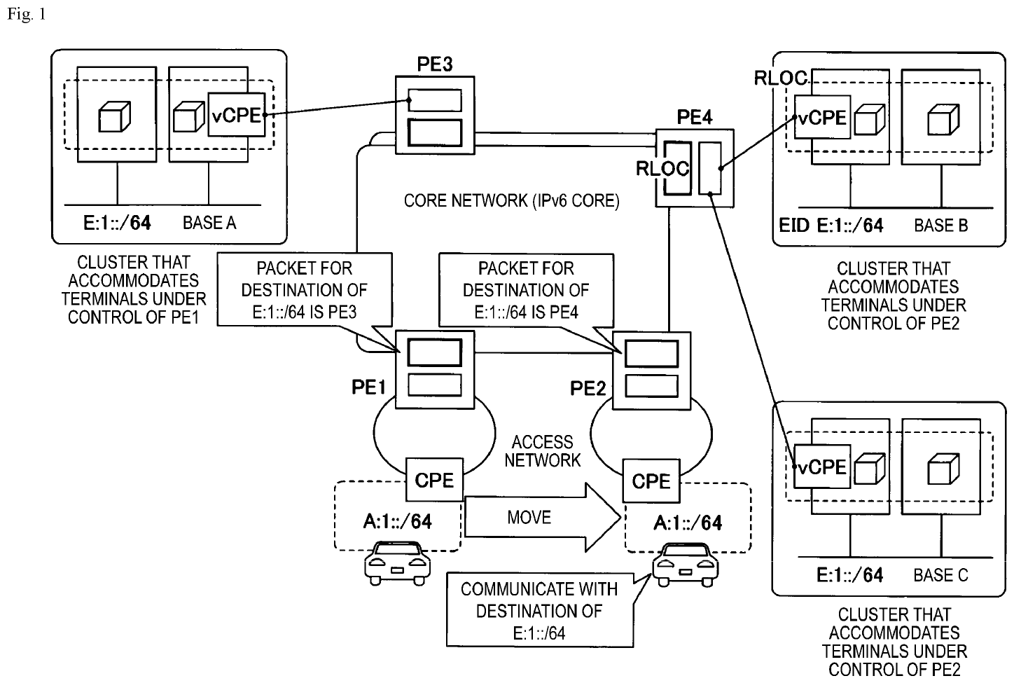

FIG. 2 is a diagram illustrating a system configuration example according to a first embodiment.

FIG. 3 is a diagram illustrating a hardware configuration example of a path information managing apparatus 10 according to the first embodiment.

FIG. 4 is a diagram illustrating a functional configuration example of a routing information management system 1 according to the first embodiment.

FIG. 5 is a sequence diagram for describing an example of a processing procedure executed in the first embodiment.

FIG. 6 is a diagram illustrating a configuration example of a connection-destination information management table 12.

FIG. 7 is a diagram illustrating a configuration example of a cluster information management table 32.

FIG. 8 is a diagram illustrating setting contents of a connection-source accommodation router R2.

FIG. 9 is a diagram illustrating a system configuration example according to a second embodiment.

FIG. 10 is a diagram illustrating a functional configuration example of an aggregation router control device 40.

FIG. 11 is a sequence diagram for describing an example of a processing procedure executed in the second embodiment.

FIG. 12 is a diagram illustrating an example of a processing pattern.

FIG. 13 is a diagram illustrating a configuration example of bits corresponding to a destination of a packet.

### DESCRIPTION OF EMBODIMENTS

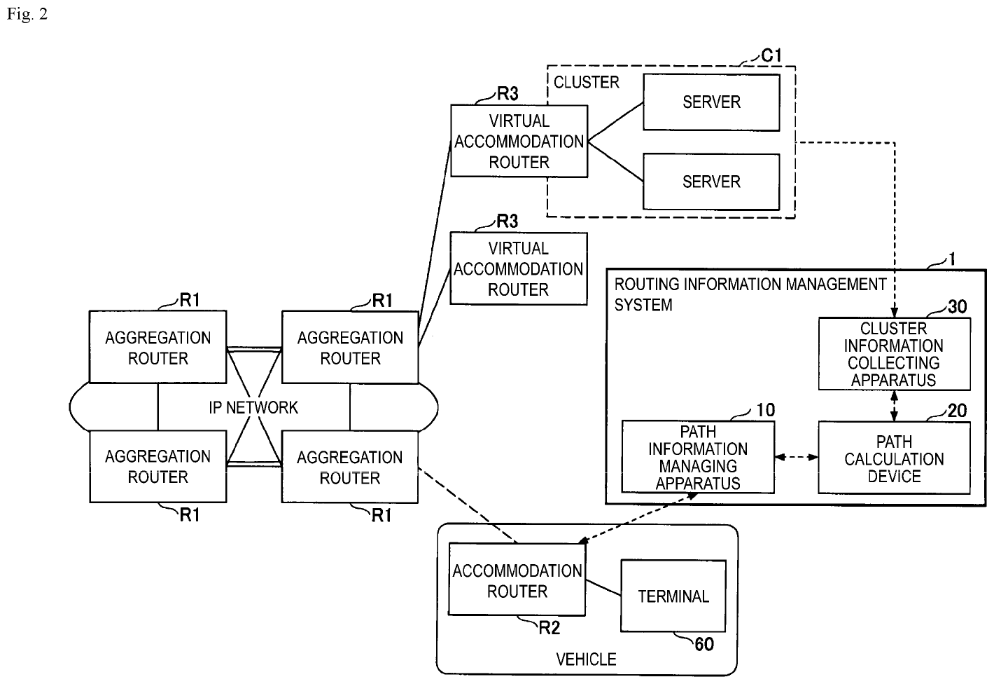

Hereinafter, embodiments of the present disclosure will be described with reference to the drawings. FIG. 2 is a diagram illustrating a system configuration example according to a first embodiment. In FIG. 2, for example, an accommodation router R2 (for example, customer premises equipment (CPE)) that is installed in a vehicle and accommodates a terminal 60 in the vehicle and a virtual accommodation router R3 (for example, virtual customer premises equipment (vCPE)) that accommodates a server group constituting a cluster C1 are connected to an IP network (for example, a WAN or a carrier network) including a plurality of aggregation routers R1 (for example, a provider edge router (PE)). A routing information management system 1 that includes one or more computers can communicate with the accommodation router R2 and the cluster C1.

The routing information management system 1 receives an inquiry in which a virtual IP address (VIP) is specified as address information of a connection destination from the accommodation router R2 (accommodation router R2 in the vehicle) as a connection source. Then, the routing information management system 1 transmits, to the accommodation router R2 as the connection source as a response, information necessary for establishing an overlay network (for example, a virtual private network (VPN)) between the accommodation router R2 as the connection source, the virtual accommodation router R3 that accommodates a server as a connection destination, and a higher aggregation router R1.

In FIG. 2, the routing information management system 1 includes computers, such as a path information managing apparatus 10, a path calculation device 20, and a cluster information collecting apparatus 30. The cluster information collecting apparatus 30 collects the information on the cluster C1 under control of each virtual accommodation router R3. The path information managing apparatus 10 receives an inquiry from the accommodation router R2 as the connection source and transmits path information to the accommodation router R2 as the connection destination and the higher aggregation router R1 as a response. In a case where the path cannot be uniquely specified, the path information managing apparatus 10 transmits an inquiry of a logic for selecting a path to the path calculation device 20. The path calculation device 20 generates the logic in advance based on the information collected by the cluster information collecting apparatus 30, and transmits the logic to the path information managing apparatus 10 when the inquiry is received.

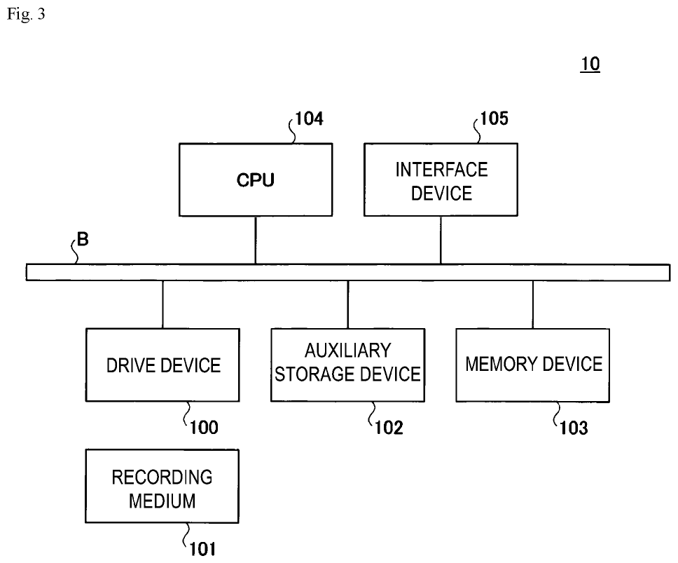

FIG. 3 is a diagram illustrating a hardware configuration example of the path information managing apparatus 10 according to the first embodiment. The path information managing apparatus 10 in FIG. 3 includes, for example, a drive device 100, an auxiliary storage device 102, a memory device 103, a CPU 104, and an interface device 105, which are connected to each other by a bus B.

A program that realizes processing in the path information managing apparatus 10 is provided by a recording medium 101 such as a CD-ROM. When the recording medium 101 storing the program is set in the drive device 100, the program is installed in the auxiliary storage device 102 from the recording medium 101 via the drive device 100. However, the program does not necessarily have to be installed from the recording medium 101, and may be downloaded from another computer via a network. The auxiliary storage device 102 stores the installed program and also stores necessary files, data, and the like.

The memory device 103 reads and stores the program from the auxiliary storage device 102 when the program is instructed to start. The CPU 104 executes a function relevant to the path information managing apparatus 10 according to the program stored in the memory device 103. The interface device 105 is used as an interface for connection to a network.

The cluster information collecting apparatus 30 and the path calculation device 20 may also have the similar hardware configuration to the configuration in FIG. 3. Alternatively, two or more apparatuses of the path information managing apparatus 10, the cluster information collecting apparatus 30, and the path calculation device 20 may be implemented by the same computer.

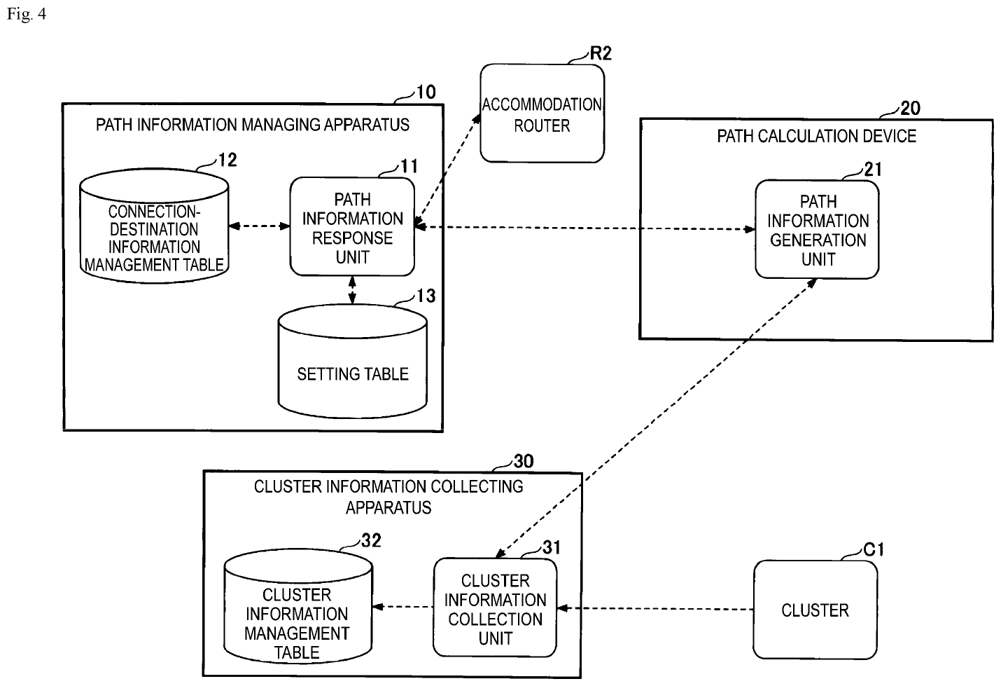

FIG. 4 is a diagram illustrating a functional configuration example of the routing information management system 1 according to the first embodiment. In FIG. 3, the path information managing apparatus 10 includes a path information response unit 11. The path information response unit 11 is realized by processing of causing the CPU 104 to execute one or more programs installed in the path information managing apparatus 10. The path information response unit 11 uses a table (storage unit) such as a connection-destination information management table 12 and a setting table 13. These storage units can be realized by using, for example, the auxiliary storage device 102 or a storage device that can be connected to the path information managing apparatus 10 via the network.

The path information response unit 11 refers to the connection-destination information management table 12 to specify a path for the connection destination (set of RLOCs of the aggregation router R1 and each accommodation router R2 as the connection destination), in response to an inquiry for the connection destination from the accommodation router R2 as the connection source. In a case where the path information response unit 11 cannot uniquely specify the path for the connection destination and needs to transmit one path as a response, the path information response unit 11 inquires the path calculation device 20 for a logic (hereinafter referred to as a “selection logic”) for selecting the path for the connection destination. After acquiring the selection logic from the path calculation device 20, the path information response unit 11 generates path information based on the acquired selection logic and transmits the path information to the accommodation router R2 as the connection source, as a response.

In the setting table 13, information (rules) is set in advance, the information defining the format of the path information in a case where the path for the connection destination from the accommodation router R2 as the connection source cannot be uniquely specified (in a case where there are a plurality of candidates). For example, as such information, “transmit all of a plurality of candidates as a response” (hereinafter, referred to as “Rule 1”) and “transmit any one of a plurality of candidates as a response” (hereinafter, referred to as “Rule 2”) are set. Thus, in a case where Rule 2 is set in the setting table 13, the path information response unit 11 inquires the path calculation device 20 for the selection logic.

The cluster information collecting apparatus 30 includes a cluster information collection unit 31. The cluster information collection unit 31 is realized by processing of causing a CPU of the cluster information collecting apparatus 30 to execute one or more programs installed in the cluster information collecting apparatus 30. The cluster information collecting apparatus 30 also uses a storage unit such as a cluster information management table 32. The cluster information management table 32 can be realized by using, for example, an auxiliary storage device of the cluster information collecting apparatus 30, a storage device connectable to the cluster information collecting apparatus 30 via a network, or the like.

The cluster information collection unit 31 collects pieces of information (hereinafter, referred to as “cluster information”) indicating the current state of the cluster C1 in each virtual accommodation router R3, and records the information in the cluster information management table 32. The cluster information collection unit 31 also transmits the cluster information recorded in the cluster information recorded in the cluster information management table 32 in response to the inquiry from the path calculation device 20. The cluster information management table 32 may be stored for each type of application or may be common to a plurality of applications.

The path calculation device 20 includes a path information generation unit 21. The path information generation unit 21 is realized by processing of causing a CPU of the path calculation device 20 to execute one or more programs installed in the path calculation device 20.

The path information generation unit 21 generates a selection logic for implementing the traffic control on the path to the accommodation router R2 as the connection destination, in response to the inquiry from the path information response unit 11 in the path information managing apparatus 10. For example, the path information generation unit 21 acquires the cluster information from the cluster information collecting apparatus 30, and determines the selection method or the use method of the aggregation router R1 and the virtual accommodation router R3 as the connection destination, based on a cluster C1 size of each cluster C1 and the status (including load status) of the cluster such as the current use rate of the cluster C1. Then, the path information generation unit 21 generates the selection logic and transmits the selection logic to the path information managing apparatus 10.

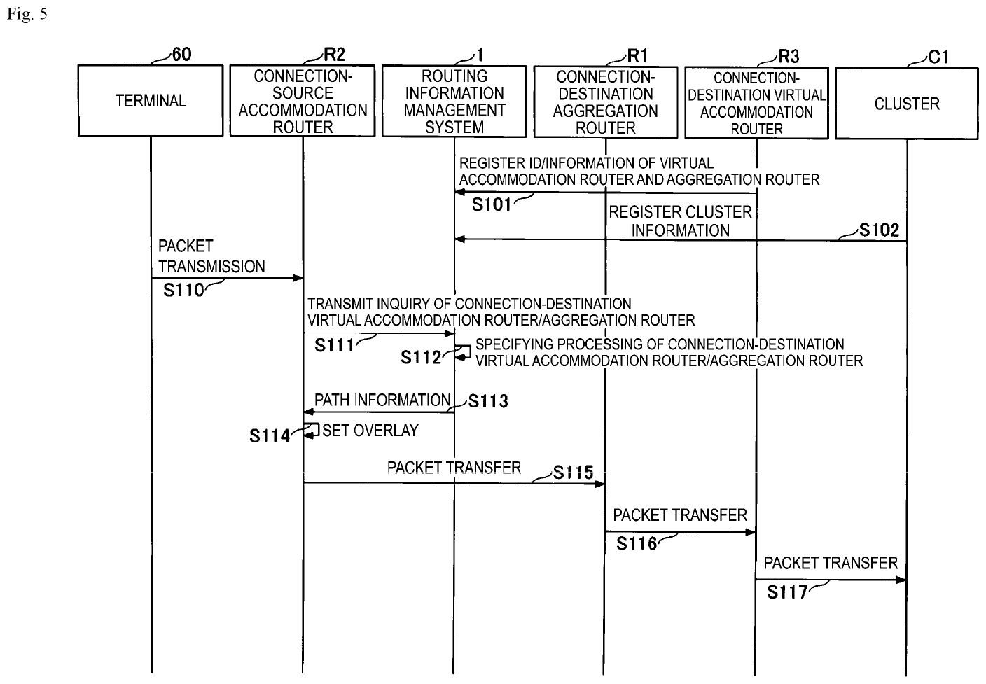

Hereinafter, a processing procedure which is executed in the routing information management system 1 will be described. FIG. 5 is a sequence diagram for describing an example of the processing procedure executed in the first embodiment. FIG. 5 describes a procedure for establishing an overlay network from the accommodation router R2 as the connection source to the virtual accommodation router R3 as the connection destination and performing communication.

First, steps S101 and S102 are executed as advance preparation.

In step S101, the virtual accommodation router R3 that may be the connection destination registers, in the connection-destination information management table 12, for example, the ID (locator) of the virtual accommodation router R3 and the ID (locator) of the higher aggregation router R1 of the virtual accommodation router R3, in association with the EID (“inquiry ID” described later) serving as an inquiry target by designation of the VIP.

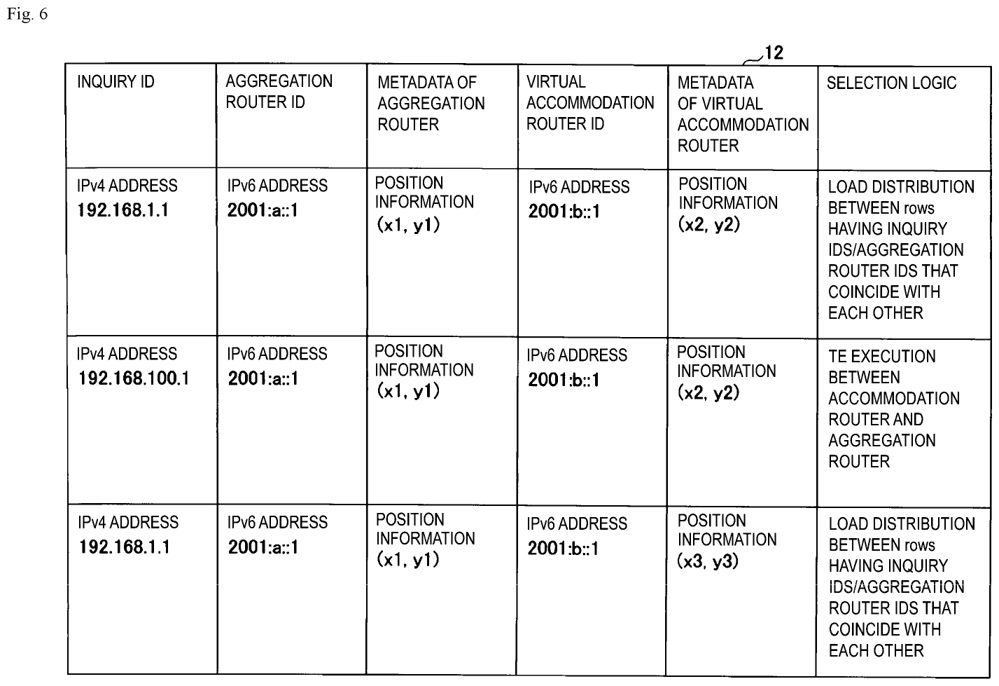

FIG. 6 is a diagram illustrating a configuration example of the connection-destination information management table 12. As illustrated in FIG. 6, each record of the connection-destination information management table 12 includes items such as an “inquiry ID”, an “aggregation router ID”, “metadata of aggregation router”, a “virtual accommodation router ID”, “metadata of virtual accommodation router”, and a “selection logic”. The value of the “inquiry ID” is the VIP (EID) inquired as address information of a destination (connection destination) from a connection source. The “aggregation router ID” is the RLOC of the aggregation router R1. The “metadata of aggregation router” is, for example, geographic position information (such as latitude and longitude) of the aggregation router R1. The “virtual accommodation router ID” is the RLOC of the virtual accommodation router R3. The “metadata of virtual accommodation router” is, for example, geographical position information (such as latitude and longitude) of a base or the like in which the virtual accommodation router R3 is disposed. The “selection logic” is a logic for selecting any record (any path) in a case where there are a plurality of records (that is, paths) corresponding to the same inquiry ID.

In step S101, a record including the “inquiry ID”, the “aggregation router ID”, the “metadata of aggregation router”, the “virtual accommodation router ID”, and the “metadata of virtual accommodation router” is registered from each virtual accommodation router R3. Thus, the value of the “selection logic” is not recorded in the record registered at this time. “TE” in the second record in FIG. 6 is an abbreviation for traffic engineering.

In step S102, each cluster C1 in each virtual accommodation router R3 that may be the connection destination registers the corresponding cluster information in the cluster information management table 32.

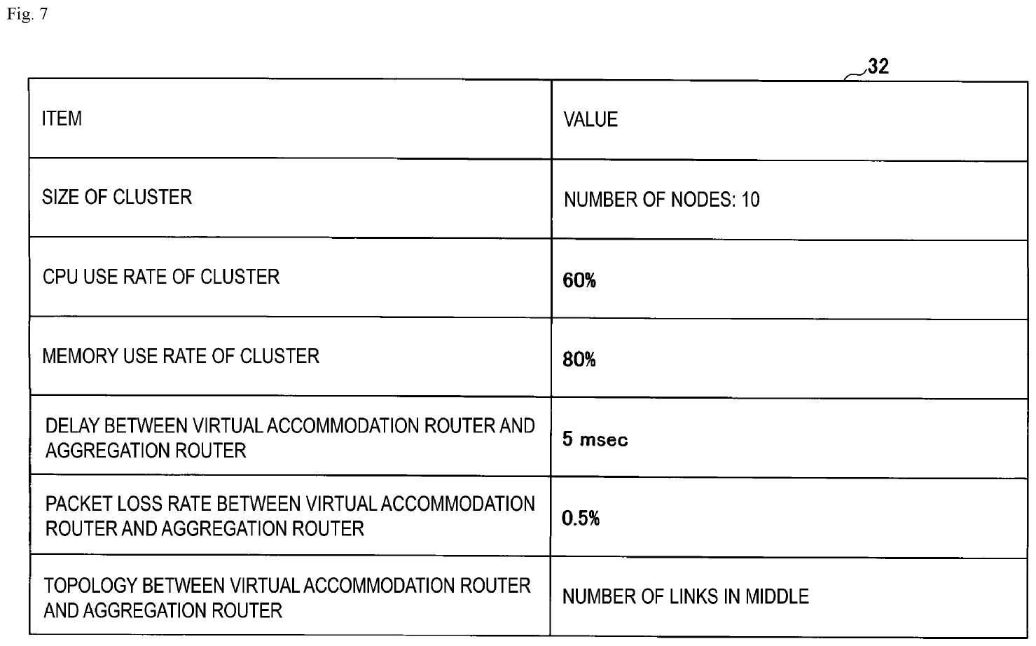

FIG. 7 is a diagram illustrating a configuration example of the cluster information management table 32. The cluster information management table 32 is generated for each cluster C1 and is stored in association with the ID (RLOC) of the virtual accommodation router R3 corresponding to the cluster C1. One cluster information management table 32 stores, for one cluster C1, a “size of cluster”, a “CPU use rate of cluster”, a “memory use rate of cluster”, a “delay between virtual accommodation router R3 and aggregation router R1 (corresponding to the cluster)”, a “packet loss rate between virtual accommodation router R3 and aggregation router R1 (corresponding to the cluster)”, a “topology between virtual accommodation router R3 and aggregation router R1 (corresponding to the cluster)”, and the like.

The contents of the cluster information management table 32 corresponding to the cluster C1 are updated by the cluster C1 in response to a change in the state of the cluster C1 or periodically.

Then, when a packet (hereinafter, referred to as a “target packet”) is transmitted from the terminal 60 (S110), step S111 and the subsequent steps are executed.

In step S111, the connection-source accommodation router R2 that accommodates the terminal 60 transmits an inquiry of the connection-destination virtual accommodation router R3 and the connection-destination aggregation router R1 to the routing information management system 1, based on the VIP (EID (endpoint identifier)) of a destination contained in the header of a target packet.

The routing information management system 1 executes specifying processing of the connection-destination virtual accommodation router R3 and the connection-destination aggregation router R1 in response to the inquiry (S112).

Specifically, the path information response unit 11 searches the connection-destination information management table 12 (FIG. 6) for a record related to the “inquiry ID” that coincides with the EID contained in the inquiry. In a case where there is one corresponding record, the path information response unit 11 generates path information including the values of the “inquiry ID”, the “aggregation router ID”, and the “accommodation router ID” of the record.

In a case where there are a plurality of corresponding records and no value is stored (cached) in the “selection logic” in the plurality of records, the path information response unit 11 specifies the virtual accommodation router ID of each of the plurality of records for the path information generation unit 21 and transmits an inquiry of the selection logic to the path information generation unit 21. The path information generation unit 21 acquires the cluster information stored in the cluster information management table 32 corresponding to the designated virtual accommodation router ID, from the cluster information collecting apparatus 30. Then, the path information generation unit 21 generates the selection logic based on the cluster information, and transmits the selection logic to the path information response unit 11. The path information response unit 11 records (caches) the selection logic in the “selection logic” in the plurality of records. When no value is stored (cached) in the “selection logic” in the plurality of records, the path information response unit 11 acquires the value (logic).

Then, the path information response unit 11 calculates a weight for each record (each path) based on the selection logic. At this time, the “metadata of aggregation router” and the “metadata of virtual accommodation router” contained in each record may be considered. In this case, the inquiry in step S111 may contain the position information of the connection-source accommodation router R2. The path information response unit 11 may obtain the distance between the position information and the metadata of each record (each path) and calculate the weight such that a the weight of the shorter distance becomes large. Then, the path information response unit 11 refers to the setting table 13 to determine whether any of Rules 1 and 2 is set.

In a case where Rule 1 is set, the path information response unit 11 generates path information including the “inquiry ID”, the “aggregation router ID”, and the “virtual accommodation router ID” of each of the plurality of records and the weight calculated for each record. In a case where Rule 2 is set, the path information response unit 11 selects any one record from the plurality of records based on the weight of each record. For example, each record may be selected with a probability depending on the weight. The path information response unit 11 generates path information including the “inquiry ID”, the “aggregation router ID”, and the “virtual accommodation router ID” of the selected one record.

Following step S112, the path information response unit 11 transmits the generated path information to the connection-source accommodation router R2 (S113). The connection-source accommodation router R2 sets the path information as the setting of an overlay network, in the connection-source accommodation router R2 (S114).

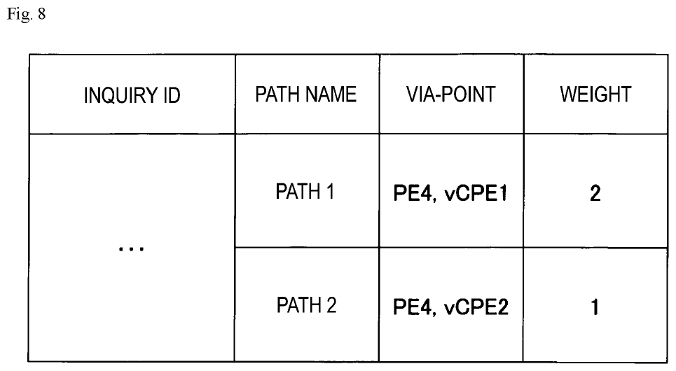

FIG. 8 is a diagram illustrating setting contents of the connection-source accommodation router R2. FIG. 8 illustrates an example in which a “path name”, a “via-point”, and a “weight” are set in the “inquiry ID” in association with each other. The via-point is the “aggregation router ID” and the “virtual accommodation router ID”. The “weight” is the calculated weight for the path.

In a case where a path corresponding to the “inquiry ID” is uniquely determined, or in a case where Rule 2 is adopted, there may be one “path name” and one “via-point” corresponding to the “inquiry ID”, and the value of the “weight” may be empty.

Then, the connection-source accommodation router R2 encapsulates the target packet to be routed to the “via point” (hereinafter, referred to as a “target via-point”) corresponding to the “inquiry ID” that coincides with the VIP of the destination of the target packet, and then transfers the encapsulated target packet (S115). In a case where there are a plurality of “via-points” corresponding to the “inquiry ID” that coincides with the VIP of the destination of the target packet, the connection-source accommodation router R2 selects any one of the “via-points” as the target via-point based on the “weight” corresponding to each “via-point”.

Then, the target packet is transferred to the cluster C1 under control of the virtual accommodation router R3 via the aggregation router R1 and the virtual accommodation router R3 related to the target via-point (S116, S117).

As described above, according to the first embodiment, even in a case where the virtual IP address is specified to the destination, an End-to-End overlay network from the accommodation router R2 (for example, CPE) as the connection source to the virtual accommodation router R3 (for example, vCPE) as the connection destination is uniquely established. Thus, it is possible to uniquely specify the path (aggregation router R1 and virtual accommodation router R3) for the connection destination.

Next, a second embodiment will be described. The second embodiment will be described with respect to points different from the first embodiment. Points not particularly mentioned in the second embodiment may be the same as those in the first embodiment.

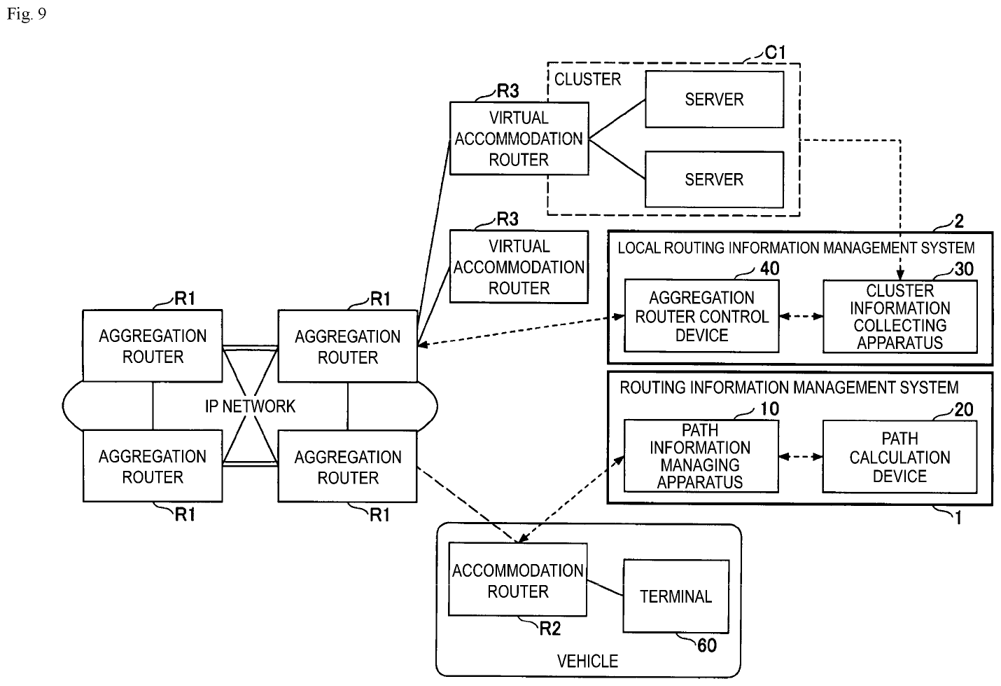

FIG. 9 is a diagram illustrating a system configuration example according to the second embodiment. In FIG. 9, the same parts as those in FIG. 2 are denoted by the same reference signs and description thereof will be omitted.

In FIG. 9, the cluster information collecting apparatus 30 is separated from the routing information management system 1 and is included in a local routing information management system 2 distributed for each aggregation router R1. The local routing information management system 2 specifies the virtual accommodation router R3 that accommodates a server as a connection destination, and sets information necessary for establishing an overlay network from the higher aggregation router R1, in the aggregation router R1. To this end, the local routing information management system 2 further includes an aggregation router control device 40.

The aggregation router control device 40 may also have a hardware configuration as illustrated in FIG. 3. In the second embodiment, the cluster information collecting apparatus 30 and the aggregation router control device 40 may be implemented by using the same computer.

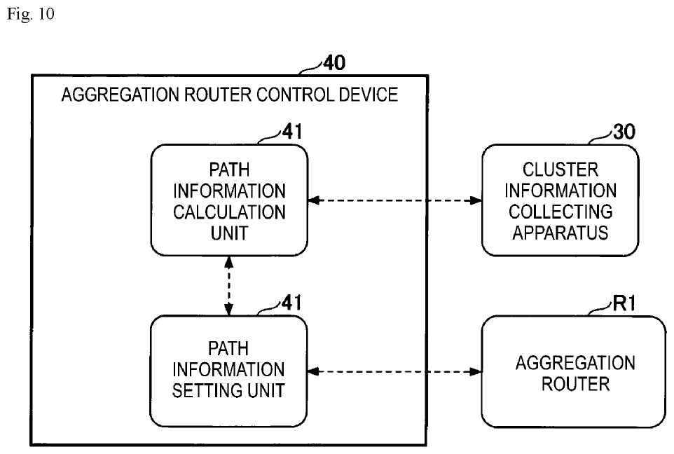

FIG. 10 is a diagram illustrating a functional configuration example of the aggregation router control device 40. In FIG. 10, the aggregation router control device 40 includes a path information calculation unit 41 and a path information setting unit 42. Each of these units is realized by processing in which one or more programs installed in the aggregation router control device 40 is executed by the CPU of the aggregation router control device 40.

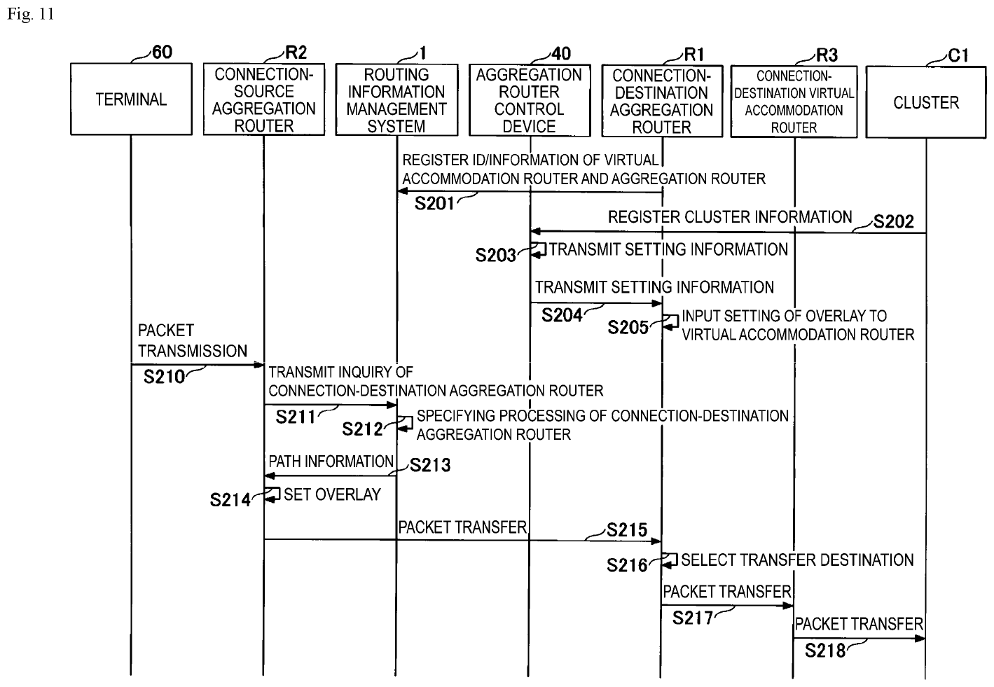

FIG. 11 is a sequence diagram for describing an example of the processing procedure executed in the second embodiment. FIG. 11 describes a procedure in which an overlay network from the accommodation router R2 as the connection source to the aggregation router R1 as the connection destination is established and an overlay network from the aggregation router R1 as the connection destination to the virtual accommodation router R3 as the connection destination is established, and communication is executed.

First, steps S201 to S205 are executed as advance preparation.

In step S201, the aggregation router R1 that can be the connection destination registers the ID (locator) of the aggregation router R1 and the ID (locator) of the virtual accommodation router R3, in the connection-destination information management table 12 (FIG. 6) in association with the EID (“inquiry ID”) serving as an inquiry target by designation of the VIP, for each virtual accommodation router R3 under control of the aggregation router R1. Thus, in the case of the aggregation router R1 that controls a plurality of virtual accommodation routers R3, a plurality of records are registered in the connection-destination information management table 12. In the second embodiment, the “ID of virtual accommodation router” and the “metadata of virtual accommodation router” may not be registered in the connection-destination information management table 12 (FIG. 6). In this case, one record may be registered for each aggregation router R1 in the connection-destination information management table 12 (FIG. 6).

In step S202, each cluster C1 in each virtual accommodation router R3 that may be the connection destination registers the corresponding cluster information in the cluster information management table 32 (FIG. 7).

In step S203, the path information calculation unit 41 in the aggregation router control device 40 generates setting information for implementing the traffic control in a path to the virtual accommodation router R3 as the connection destination. For example, in a case where the aggregation router R1 corresponding to the aggregation router control device 40 is connected to a plurality of virtual accommodation routers R3, the path information calculation unit 41 acquires cluster information from the cluster information collecting apparatus 30, and selects the virtual accommodation router R3 as the connection destination, based on the cluster information (based on the status (including load status) of the cluster). Then, the path information calculation unit 41 generates the setting information including the selection result (RLOCs of the one or more selected virtual accommodation routers R3), and a processing pattern indicating a use method of the selection result and parameters necessary for performing the processing pattern, and the like. The path information calculation unit 41 transmits the generated setting information to the path information setting unit 42. The processing pattern is defined in advance and is stored in the aggregation router control device 40.

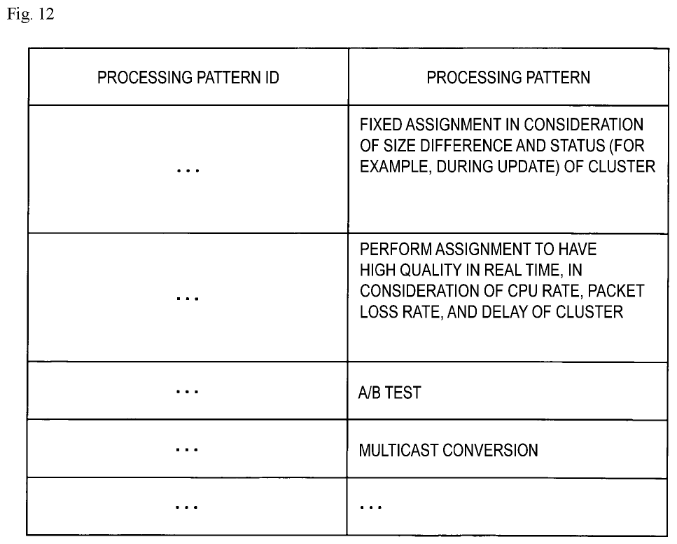

FIG. 12 is a diagram illustrating an example of the processing pattern. As illustrated in FIG. 12, a processing pattern ID for identifying a processing pattern is assigned to each processing pattern. A rule for selecting the virtual accommodation router R3 is defined in each processing pattern.

Then, the path information setting unit 42 in the aggregation router control device 40 transmits (sets) the setting information to the aggregation router R1 corresponding to the aggregation router control device 40 (S204). The aggregation router R1 inputs the setting of an overlay network addressed to the virtual accommodation router R3 as the connection destination, by associating the setting information with the “inquiry ID” (S205). As a result, the overlay network is established between the aggregation router R1 and the virtual accommodation router R3.

Then, when a packet (referred to as a “target packet” below) is transmitted from the terminal 60 (S210), step S211 and the subsequent steps are executed.

In step S211, the connection-source accommodation router R2 that accommodates the terminal 60 transmits an inquiry of the connection-destination aggregation router R1 to the routing information management system 1, based on the endpoint identifier (EID) of a destination contained in the header of the target packet.

The routing information management system 1 executes specifying processing of the connection-destination aggregation router R1 in response to the inquiry (S212). The contents of the specifying processing of the connection-destination aggregation router R1 may be similar to the processing contents of step S112 in FIG. 5. In step S212, the connection-destination virtual accommodation router R3 may not be specified. Thus, in step S212, path information that does not contain the RLOC of the connection-destination virtual accommodation router R3 is generated.

Following step S212, the path information response unit 11 transmits the generated path information to the connection-source accommodation router R2 (S213). The connection-source accommodation router R2 sets the path information as the configuration of an overlay network, in the connection-source accommodation router R2 (S214). For example, information similar to that in FIG. 8 is set. The “via-point” does not include the RLOC of the virtual accommodation router R3.

Then, the connection-source accommodation router R2 encapsulates the target packet to be routed to the “via point” (hereinafter, referred to as a “target via-point” below) corresponding to the “inquiry ID” that coincides with the VIP of the destination of the target packet, and then transfers the encapsulated target packet (S215). In a case where there are a plurality of “via-points” corresponding to the “inquiry ID” that coincides with the VIP of the destination of the target packet, the connection-source accommodation router R2 selects any one of the “via-points” as the target via-point based on the “weight” corresponding to each “via-point”.

When receiving the target packet, the connection-destination aggregation router R1 related to the target via-point selects the virtual accommodation router R3 as a transfer destination (S216).

For example, the transfer destination may be selected using a Function function (SRv6 Network Programming, draft-ietf-spring-srv6-network-program-06) of the SRv6 SID. In this case, the connection-destination aggregation router R1 selects the transfer destination based on the processing pattern corresponding to the processing pattern ID specified to some bits of the EID (VIP) of the destination of the target packet.

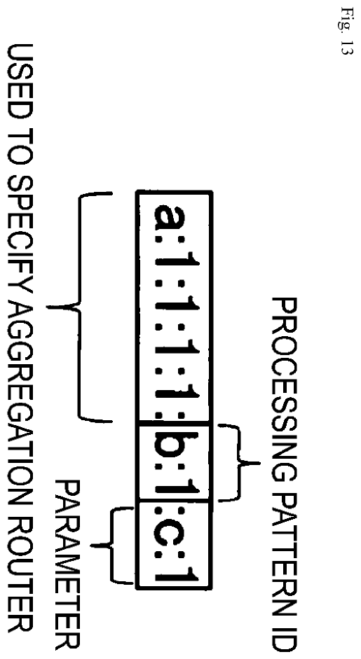

FIG. 13 is a diagram illustrating a configuration example of bits corresponding to a destination of a packet. FIG. 13 illustrates an example in which the upper bits are bits used to specify the connection-destination aggregation router R1, the subsequent bits indicate a processing pattern ID, and the subsequent bits indicate a parameter of a processing pattern corresponding to the processing pattern ID. For example, “c: 1” corresponding to the parameter indicates that the assignment weight of the virtual accommodation router R3 as the candidate for the connection destination is set to 2:1. As described above, the Function can be embedded in the encapsulation header between the connection-source accommodation router R2 and the connection-destination aggregation router R1 or in the VIP specified in the IP header before the encapsulation. The information of the encapsulation header may be cached in the connection-destination aggregation router R1 before decapsulation.

Thus, in this case, the connection-destination aggregation router R1 specifies the processing pattern with reference to the bits corresponding to the processing pattern ID in the EID (VIP) of the destination of the target packet, and selects the transfer destination based on the processing pattern (by applying the parameter to the processing pattern). The parameter value may be different depending on the connection-destination aggregation router R1. Thus, only the parameter portion of the VIP may be updated by network address translation (NAT) of the connection-destination aggregation router R1, or the parameter contained in the setting information received in step S204 may be applied without specifying the parameter in the VIP.

Alternatively, the connection-destination aggregation router R1 may select the connection destination by policy-based routing, NAT, or encapsulation.

Alternatively, the connection-destination aggregation router R1 may select the transfer destination by autonomous processing defined in the connection-destination aggregation router R1, such as round robin of routes addressed to a plurality of virtual accommodation routers R3.

Subsequently, the connection-destination aggregation router R1 transfers the target packet via the overlay network addressed to the selected transfer destination (S217, S218). When the target packet is transferred, the connection-destination aggregation router R1 decapsulates the target packet corresponding to the overlay network between the connection-source accommodation router R2 and the connection-destination aggregation router R1. The connection-destination aggregation router R1 specifies the virtual accommodation router R3 as the transfer destination by any method such as referring to the cache value of the encapsulation header before the decapsulation or the IP header after the decapsulation, and then encapsulates the target packet after the decapsulation with the RLOC of the virtual accommodation router R3. The connection-destination aggregation router R1 transfers the target packet after the encapsulation.

As described above, according to the second embodiment, even in a case where a virtual IP address is specified to a destination and there are a plurality of virtual accommodation routers R3 under the control of the aggregation router R1 as the connection destination, it is possible to select the virtual accommodation router R3 as the connection destination in accordance with the requirement of the user (for example, performing traffic control such as restricting the flow rate for a specific cluster C1).

The overlay network (between the connection-source accommodation router R2 and the connection-destination virtual accommodation router R3) established in the first embodiment or the overlay network (between the connection-destination aggregation router R1 and the connection-destination virtual accommodation router R3) established in the second embodiment is terminated at the connection-destination virtual accommodation router R3.

The IP packet decapsulated from the overlay network terminates in a service corresponding to the VIP inside the cluster C1. The terminating endpoint may be a workload on which the application body operates or a middle box such as a load balancer that bundles the application.

In the present embodiment, the routing information management system 1, or the routing information management system 1 and the local routing information management system 2 are examples of a path information managing apparatus. The connection-destination information management table 12 is an example of a storage unit. The path information response unit 11 is an example of an acquisition unit and a transmission unit. The path information generation unit 21 is an example of a selection unit. The aggregation router control device 40 is an example of a setting unit.

Although the embodiments of the present disclosure have been described in detail above, the present disclosure is not limited to such specific embodiments, and various modifications and change can be made within the scope of the gist of the present disclosure described in the aspects.

### REFERENCE SIGNS LIST

1 Routing information management system
2 Local routing information management system
10 Path information managing apparatus
11 Path information response unit
12 Connection-destination information management table
13 Setting table
20 Path calculation device
21 Path information generation unit
30 Cluster information collecting apparatus
31 Cluster information collection unit
32 Cluster information management table
40 Aggregation router control device
41 Path information calculation unit
42 Path information setting unit
60 Terminal
100 Drive device
101 Recording medium
102 Auxiliary storage device
103 Memory device
104 CPU
105 Interface device
B Bus
C1 Cluster
R1 Aggregation router
R2 Accommodation router
R3 Virtual accommodation router

1. A path information managing apparatus comprising:
a memory configured to store, in association with a virtual IP address, a plurality of locators of a plurality of aggregation routers and a plurality of locators of a plurality of virtual accommodation routers, each of the plurality of virtual accommodation routers being accommodated in each of the plurality of aggregation routers and accommodating a cluster;
a receive configured to acquire, in response to an inquiry for a virtual IP address specified to a destination of a packet, the inquiry being transmitted from an accommodation router that has received the packet from a terminal, the locator of the aggregation router and the plurality of locators of the plurality of virtual accommodation routers that are associated with the virtual IP address in the memory; and
a transmitter configured to transmit, to the accommodation router, the acquired locator of the aggregation router, the acquired locator of each of the plurality of virtual accommodation routers and a weight of each of the plurality of virtual accommodation routers, or the locator of any one of the plurality of virtual accommodation routers.

2. The path information managing apparatus according to claim 1, further comprising:
a processor that executes instructions to select any one of the plurality of virtual accommodation routers based on a status of a cluster accommodated by each of the plurality of virtual accommodation routers or position information of each of the plurality of virtual accommodation routers,
wherein the transmitter is configured to transmit, to the accommodation router, the locator of the aggregation router and the locator of the one virtual accommodation router selected by the selection unit.

3. A path information managing apparatus comprising:
a memory configured to store, in association with a virtual IP address, a plurality of locators of a plurality of aggregation routers that accommodates a plurality of virtual accommodation routers each accommodating a cluster;
a receiver configured to acquire, in response to an inquiry for a virtual IP address specified to a destination of a packet, the inquiry being transmitted from an accommodation router that has received the packet from a terminal, a locator of the aggregation router associated with the virtual IP address in the memory;
a transmitter configured to transmit the acquired locator of the aggregation router to the accommodation router; and
a processor configured to execute instructions to select one or more virtual accommodation routers from the plurality of virtual accommodation routers and set a processing pattern in the aggregation router, the processing pattern being provided for causing the aggregation router to select the selected virtual accommodation router.

4. The path information managing apparatus according to claim 3, wherein
the processor is configured to select the one or more virtual accommodation routers based on a status of a cluster accommodated by each of the plurality of virtual accommodation routers.

5. A path information managing method performed by a computer, the method comprising:
storing, in a memory and in association with a virtual IP address, a plurality of locators of a plurality of aggregation routers and a plurality of locators of a plurality of virtual accommodation routers, each of the plurality of virtual accommodation routers being accommodated in each of the plurality of aggregation routers and accommodating a cluster, in response to an inquiry for a virtual IP address specified to a destination of a packet, the inquiry being transmitted from an accommodation router that has received the packet from a terminal, acquiring a locator of the aggregation router and a locator of each of the plurality of virtual accommodation routers which are associated with the virtual IP address; and
transmitting, to the accommodation router, the acquired locator of the aggregation router, the acquired locator of each of the plurality of virtual accommodation routers and a weight of each of the plurality of virtual accommodation routers, or the locator of any one of the plurality of virtual accommodation routers.

6. (canceled)

7. (canceled)
